(19) United States
(12) Patent Application Publication
(10) Pub. No.: US 2026/0250554 A1
(43) Pub. Date: Aug. 27, 2026

(54) DEVICES AND METHODS FOR INSTALLING WINDOW BLINDS

(71) Applicant: Ashland Blinds LLC, Chicago, IL (US)

(72) Inventors: Karla J. Baumler, Chicago, IL (US); Jesus Ortiz Vargas, Chicago, IL (US)

(73) Assignee: Ashland Blinds LLC, Chicago, IL (US)

(21) Appl. No.: 19/549,668

(22) Filed: Feb. 25, 2026

Related U.S. Application Data
(60) Provisional application No. 63/763,077, filed on Feb. 25, 2025.

(51) Int. Cl. C09J 5/02; C09H 9/00; E06B 9/24

(52) U.S. Cl. CPC C09J 5/02; C09H 9/00; E06B 9/24

(57) ABSTRACT

Devices and methods for installing window blinds are disclosed. In one embodiment, an L-shaped bracket is secured to a window frame using an ultraviolet (UV) light curable adhesive. The bracket is positioned using a holder that engages a flange of the bracket to maintain alignment and apply pressure while a handheld UV light device cures the adhesive. The holder permits accurate placement and reduces user exposure to UV light during curing. In another embodiment, a flat mounting plate is secured to a window frame using a UV-curable adhesive. The flat plate may include one or more countersunk apertures and an indentation configured to receive a portion of a window blind bracket. After curing, a window blind bracket may be secured to the flat plate using mechanical fasteners. The disclosed systems allow installation of window blinds without drilling into the window frame, reducing installation time and surface damage.

### PRIORITY

The present application is related to, and claims the priority benefit of, U.S. provisional patent application Ser. No. 63/763,077, filed Feb. 25, 2025, the contents of which are incorporated herein directly and by reference in their entirety.

### BRIEF SUMMARY

The present disclosure includes disclosure of a method of affixing an L-shaped bracket or a flat plate to a window frame, as shown and/or described herein.

The present disclosure includes disclosure of a method of installing a window blind to a window frame, as shown and/or described herein.

The present disclosure includes disclosure of a method, comprising cleaning relative corners of a window frame that will receive a window blind, positioning an L-shaped bracket upon a holder of the present disclosure, applying an ultraviolet (UV) light curable adhesive to the L-shaped bracket, positioning the L-shaped bracket upon the window frame using the holder to hold the L-shaped bracket in place, applying UV light to the L-shaped bracket using a handheld UV light device to cure the adhesive and install the L-shaped bracket, and removing the holder from the L-shaped bracket.

The present disclosure includes disclosure of a method, further comprising repeating the method to install at least a second L-shaped bracket.

The present disclosure includes disclosure of a method, further comprising installing a window blind upon the installed L-shaped brackets.

The present disclosure includes disclosure of a holder, as shown and/or described herein.

The present disclosure includes disclosure of a holder, comprising a handle and an engagement portion positioned at a distal end of the handle, wherein the engagement portion has a slot defined therein with a slot opening at a distal end of the engagement portion, the slot configured to receive and engage a bracket flange of an L-shaped bracket.

The present disclosure includes disclosure of a method of securing a device to a window frame, the method comprising applying an ultraviolet (UV) light curable adhesive to the device, positioning the device upon the window frame and holding the device in place, and applying UV light to the device using a handheld UV light device to cure the adhesive and install the device to the window frame.

The present disclosure includes disclosure of a method of securing a device to a window frame, wherein the device comprises an L-shaped bracket.

The present disclosure includes disclosure of a method of securing a device to a window frame, further comprising the step of cleaning relative corners of a window frame that will receive a window blind prior to the step of positioning the device upon the window frame.

The present disclosure includes disclosure of a method of securing a device to a window frame, wherein the step of positioning the device upon the window frame and holding the device in place comprises using a holder configured to receive part of the device.

The present disclosure includes disclosure of a method of securing a device to a window frame, wherein the step of applying UV light to the device is performed while the holder is used to hold the device in place upon the window frame.

The present disclosure includes disclosure of a method of securing a device to a window frame, further comprising the step of removing the holder from the device.

The present disclosure includes disclosure of a method of securing a device to a window frame, further comprising repeating the method to install at least a second L-shaped bracket.

The present disclosure includes disclosure of a method of securing a device to a window frame, further comprising installing a window blind upon the installed L-shaped brackets.

The present disclosure includes disclosure of a method of securing a device to a window frame, wherein the holder comprises a handle and an engagement portion positioned at a distal end of the handle, wherein the engagement portion has a slot defined therein with a slot opening at a distal end of the engagement portion, the slot configured to receive and engage a bracket flange of the L-shaped bracket.

The present disclosure includes disclosure of a method of securing a device to a window frame, wherein the device comprises a flat plate, the flat plate comprising an inner surface, an outer surface, and at least one hole defined within the flat plate and countersunk from the inner surface, the at least one hole configured to receive at least part of a screw or bolt therethrough.

The present disclosure includes disclosure of a method of securing a device to a window frame, further comprising the step of cleaning relative flat sections of the front or inside top of the window frame that will receive a window blind prior to the step of positioning the device upon the window frame.

The present disclosure includes disclosure of a method of securing a device to a window frame, wherein the step of positioning the device upon the window frame and holding the device in place comprises using a holder configured to receive part of the device.

The present disclosure includes disclosure of a method of securing a device to a window frame, wherein the step of applying UV light to the device is performed while the holder is used to hold the device in place upon the window frame.

The present disclosure includes disclosure of a method of securing a device to a window frame, further comprising the steps of positioning a window blind bracket onto the flat plate installed to the window frame, and securing the window blind bracket onto the flat plate using one or more nuts.

The present disclosure includes disclosure of a method of securing a device to a window frame, further comprising repeating the method to install at least a second flat plate.

The present disclosure includes disclosure of a method of securing a device to a window frame, further comprising installing a window blind upon the installed flat plates.

The present disclosure includes disclosure of a method of securing a device to a window frame, the method comprising cleaning at least a portion of a window frame that will receive a window blind, applying an ultraviolet (UV) light curable adhesive to the device, positioning the device upon the window frame and holding the device in place, and applying UV light to the device using a handheld UV light device to cure the adhesive and install the device to the window frame.

The present disclosure includes disclosure of a method of securing a device to a window frame, wherein the device comprises an L-shaped bracket, wherein a holder is used to hold the L-shaped bracket in place while the step of applying UV light is performed.

The present disclosure includes disclosure of a method of securing a device to a window frame, further comprising the step of installing a window blind to the device to hold the window blind in place.

The present disclosure includes disclosure of a method of securing a device to a window frame, wherein the device comprises a flat plate, and wherein the method further comprises the steps of positioning a window blind bracket onto the flat plate installed to the window frame, and securing the window blind bracket onto the flat plate using one or more nuts.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a side perspective bracket holder, according to at least one embodiment of the present disclosure;

FIG. 2 shows a perspective bracket holder, according to at least one embodiment of the present disclosure;

FIG. 3 shows side views of a holder and an L-shaped bracket, according to at least one embodiment of the present disclosure;

FIG. 4 shows an L-shaped bracket positioned upon a bracket holder, according to at least one embodiment of the present disclosure;

FIG. 5 shows a block component diagram of various devices and materials used in connection with methods of the present disclosure, according to at least one embodiment of the present disclosure;

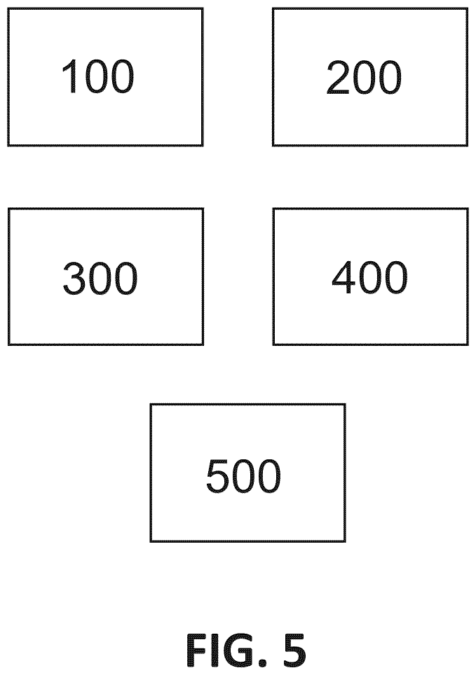

FIG. 6 shows a perspective view of a flat plate, according to at least one embodiment of the present disclosure;

FIG. 7 shows a side view of a flat plate, according to at least one embodiment of the present disclosure;

FIG. 8 shows a perspective view of a flat plate with screws or bolts positioned therethrough, according to at least one embodiment of the present disclosure;

FIG. 9 shows a side view of a flat plate with screws or bolts positioned therethrough, according to at least one embodiment of the present disclosure; and

FIG. 10 shows a flat plate coupled to a window blind bracket, according to at least one embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The present disclosure includes disclosure of devices and methods for installing window blinds. In contrast to traditional blind installation methods that require drilling into window frames, anchoring with screws, or using mechanical fasteners, the methods disclosed herein permit structural installation without penetrating the window frame substrate, thereby reducing installation time, minimizing surface damage, and allowing installation in environments where drilling is undesirable or prohibited.

### L-Shaped Bracket

In at least one embodiment of a method of the present disclosure, the method includes the step of cleaning at least the relative corners of the window frame, such as by cleaning using blown air (such as with a can of compressed air or compressed air from a mechanical air compressor) and/or using rubbing alcohol to do an initial clean. General household cleaners and/or water are not to be used in connection with this cleaning step.

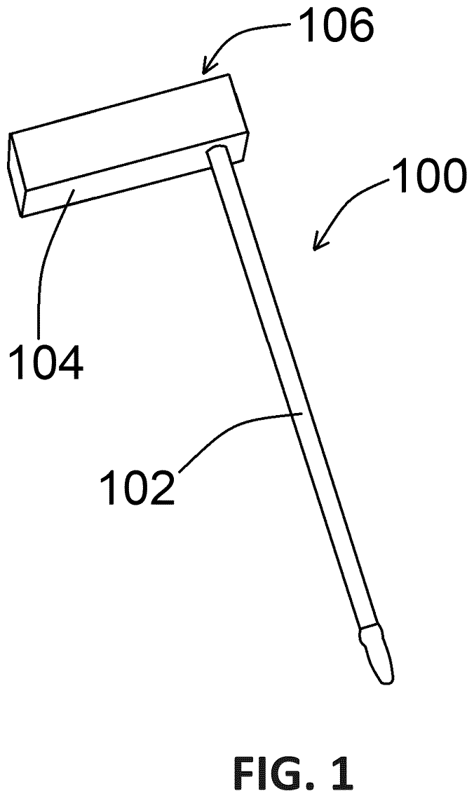

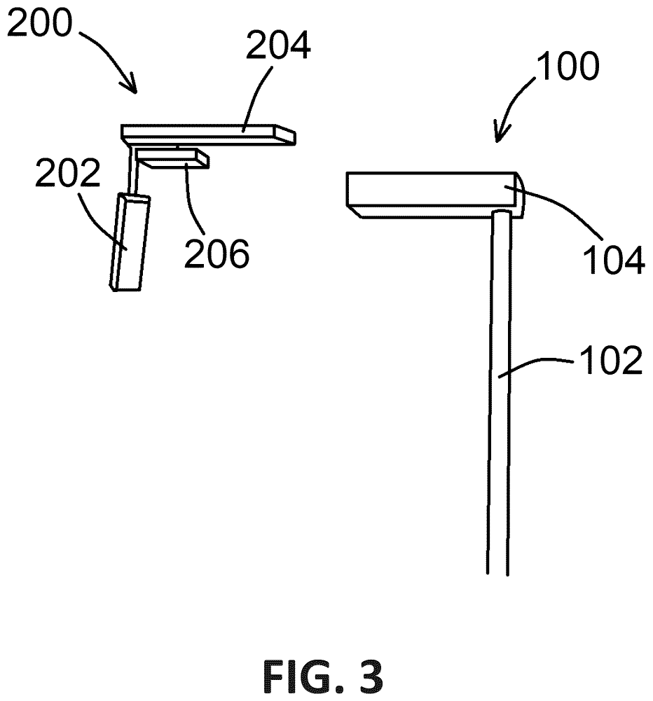

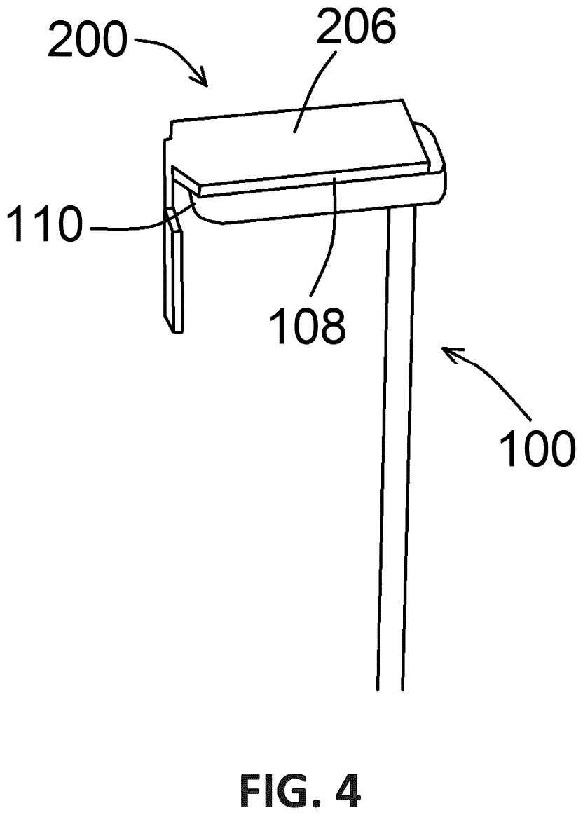

After the window frame corners are cleaned, the next step in the method is to position an L-shaped bracket 200, as shown in FIGS. 3 and 4, used to hold the window blinds 500 in place onto a holder 100, as shown in FIGS. 1, 2, 3, and 4 of the present disclosure. It is noted that this step can be performed prior to the step of cleaning at least the relative corners of the window frame, as may be desired.

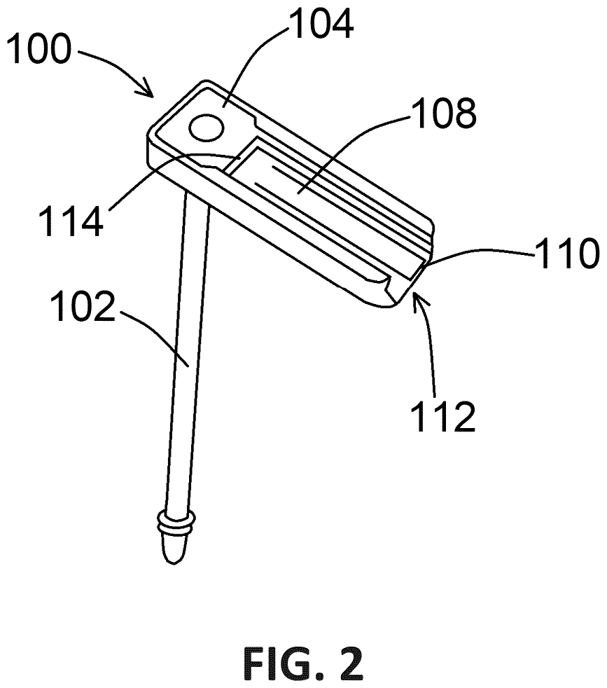

As referenced herein and as shown in FIG. 1, said holder 100 comprises a handle 102 and an engagement portion 104 positioned at a distal end 106 of said handle 102. Engagement portion 104 has a slot 108 defined therein, as shown in FIG. 2, with a slot opening 110 at a distal end 112 of said engagement portion 104 and an optional end portion 114 opposite the distal end 112 of engagement portion 104. The slot 108 is configured to receive and engage a bracket flange 206 of an L-shaped bracket 200.

L-shaped brackets 200, as shown in FIG. 3, have a first lateral portion 202 perpendicularly extending from a second lateral portion 204, forming the “L-shape.” A bracket flange 206, present along at least a portion of the second lateral portion 204, is located on a relative inside of the L-shape.

As shown in FIG. 4, the holder 100 is configured to engage and retain the L-shaped bracket 200 for ultimate attachment to a window frame. As shown therein, bracket flange 206 of L-shaped bracket 200 is positioned within slot 108 of holder 100, positioned therein by sliding bracket flange 206 into slot opening 110 of engagement portion 104 so that bracket flange 206 is positioned within slot 108.

After the L-shaped bracket 200 is positioned upon the holder 100 (such as by sliding the same into the holder 100) and the window frame corners are clean (the steps noted above, performed in either order), the next step in the method includes the step of applying an adhesive 300 upon portions of the L-shaped bracket 200 used to hold the window blinds 500 in place. In at least one embodiment, a couple of drops of adhesive 300 are positioned on a relative bottom and side of the L-shaped bracket 200 that is ultimately attached to the window frame. Turning the holder 100 with the L-shaped bracket 200 positioned thereon helps with the placement of adhesive 300 upon said L-shaped bracket 200. In a preferred embodiment, the adhesive 300 is an ultraviolet (UV) light curable acrylic adhesive 300. In at least one embodiment, the adhesive 300 is a thixotropic ultraviolet (UV) light curable acrylic adhesive 300, such as Permabond® UV643. Permabond® UV643 is a thixotropic, extremely fast UV-curable acrylic adhesive 300 developed for the fast bonding of many rigid plastics, also in combination with metals. It cures tack-free and provides excellent performance on several thermoplastics including polycarbonate, poly(methyl methacrylate) (PMMA), polyethylene terephthalate glycol (PETG), polyethylene terephthalate (PET), acrylonitrile butadiene styrene (ABS), and polyvinyl chloride (PVC). In other embodiments, the adhesive may comprise other ultraviolet-curable acrylic adhesives, epoxy-based UV-curable adhesives, hybrid adhesives, or other light-curable structural bonding materials capable of forming a load-bearing bond between metal, polymer, composite, wood, or painted window frame surfaces.

After the adhesive 300 has been applied to the relative bottom and side of the L-shaped bracket 200, the next step in the method is to position the L-shaped bracket 200 with the adhesive 300 applied thereto against a desired location of a window frame. This is performed using the holder 100 so that the holder 100 can apply pressure to the L-shaped bracket 200 against the window frame.

While the holder 100 is used to hold the L-shaped bracket 200 against the window frame under pressure, the next step of the method is to cure the adhesive using UV light. In at least one embodiment, this step is performed using a handheld UV light device 400, such as, for example, the Cool Cure Beam sold by American Ultraviolet, which is a cordless UV LED spot cure device. Exemplary UV light devices 400 of the present disclosure may output wavelengths of 365 nm, 395 nm, and/or 405 nm, at an intensity of 860 mW/cm²-13 W/cm². UV light can be applied using said UV light device 400 for between about 15 seconds and about 30 seconds per L-shaped bracket 200 attachment, such as by holding the UV light device 400 about 4-5 inches away from the L-shaped bracket 200 and shining said light on both the bottom and the side of the L-shaped bracket 200 where the adhesive 300 is located. In other embodiments, less time or more time of UV cure can take place. The holder 100 is used in this step to hold the L-shaped bracket 200 in place while applying UV light so that the user's fingers are not in the range of the UV cure light. The holder 100 essentially mimics how the blind 500 is attached to the permanent attachment, so it is the perfect vehicle to hold the L-shaped bracket 200 in place. This step is performed to position and affix at least two L-shaped brackets 200, and perhaps four L-shaped brackets 200, in place upon the relative corners of a window frame. Once each L-shaped bracket 200 is affixed to the window frame, the holder 100 can be removed from said L-shaped bracket 200 by sliding the holder 100 off of the L-shaped bracket 200.

The next step in the method is to position a window blind 500 upon said positioned L-shaped brackets 200 to hold the window blind 500 in place.

Flat Plate

In at least one embodiment of a method of the present disclosure, the method includes the step of cleaning at least the relative flat sections of the front or inside top of the window frame, such as by cleaning using blown air (such as with a can of compressed air or compressed air from a mechanical air compressor) and/or using rubbing alcohol to do an initial clean. In some embodiments, general household cleaners and/or water are not to be used in connection with this cleaning step.

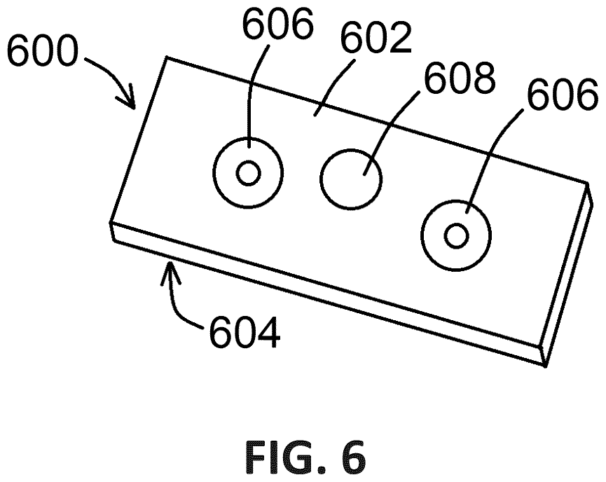

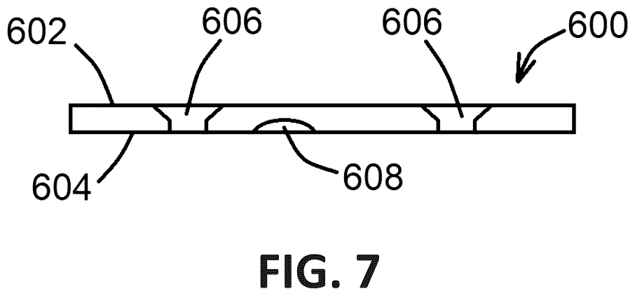

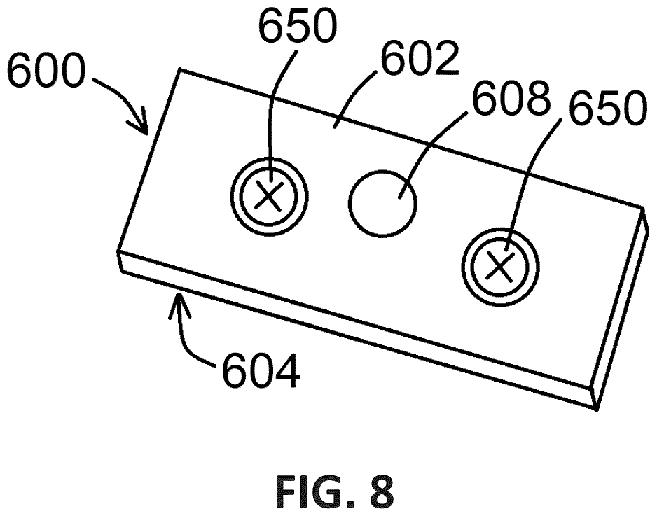

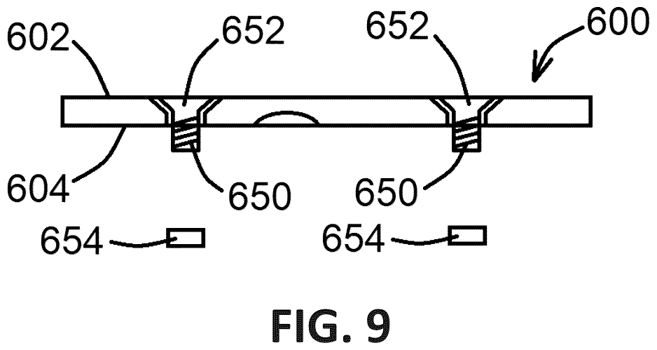

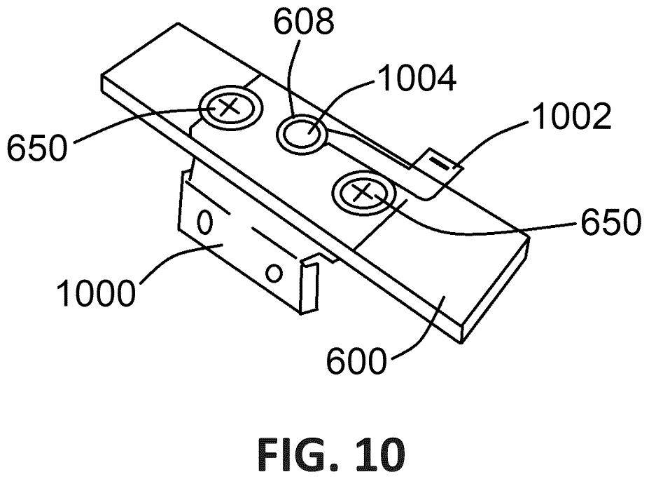

After the window frame corners are cleaned, the next step in the method is to prepare a flat plate 600, such as shown in FIGS. 6, 7, 8, 9, and 10, used to hold the window blinds 500 in place by way of a window blind bracket 1000, such as shown in FIG. 10. Flat plate 600, such as shown in FIG. 6, comprises an inner surface 602 and an outer surface 604, whereby the inner surface 602 is to receive the adhesive 300. At least one, and sometimes two, screw or bolt holes 606 are defined within flat plate 600, whereby said screw or bolt holes 606 are countersunk at the inner surface 602 (such as shown in FIGS. 6 and 7), so that said screw or bolt holes 606 can receive screws or bolts 650 therein, and whereby screw or bolt heads 652 can be received within the countersunk portion of the screw or bolt holes 606, such as shown in FIG. 9. Flat plate 600 can ultimately have a window blind bracket 1000 coupled thereto, as referenced herein, so that when flat plate 600 and window blind bracket 1000 are affixed to a window frame using an adhesive 300 as referenced herein, a window blind can be coupled one or more window blind brackets 1000 to hold said window blind in place.

An indentation 608 can be defined within flat plate 600, such as from the outer surface 604 side, as shown in FIGS. 6 and 7. Said indentation 608 is configured to receive at least part of a lever pivot mechanism 1004, such as shown in FIG. 10, when window blind bracket 1000 is ultimately secured to a flat plate 600 of the present disclosure.

A holder 100 of the present disclosure can be used to hold flat plate 600 in place, as may be desired.

After the relative flat sections of the front or inside top of the window frame are clean, the next step in the method includes the step of applying an adhesive 300 upon portions of the inner surface 602 of the flat plate 600 used to hold the window blinds 500 in place. In at least one embodiment, a couple of drops of adhesive 300 are positioned on the inner surface 602 of the flat plate 600 that is ultimately attached to the window frame. The adhesive 300 is also positioned where the screw or bolt heads 652 are located so that when the adhesive 300 cures, the screw or bolt heads 652 do not turn when applying a nut 654 thereto. In a preferred embodiment, the adhesive 300 is an ultraviolet (UV) light curable acrylic adhesive 300. In at least one embodiment, the adhesive 300 is a thixotropic ultraviolet (UV) light curable acrylic adhesive 300, such as Permabond® UV643. Permabond® UV643 is a thixotropic, extremely fast UV-curable acrylic adhesive 300 developed for the fast bonding of many rigid plastics, also in combination with metals. It cures tack-free and provides excellent performance on several thermoplastics including polycarbonate, poly(methyl methacrylate) (PMMA), polyethylene terephthalate glycol (PETG), polyethylene terephthalate (PET), acrylonitrile butadiene styrene (ABS), and polyvinyl chloride (PVC). In other embodiments, the adhesive may comprise other ultraviolet-curable acrylic adhesives, epoxy-based UV-curable adhesives, hybrid adhesives, or other light-curable structural bonding materials capable of forming a load-bearing bond between metal, polymer, composite, wood, or painted window frame surfaces.

After the adhesive 300 has been applied to the inner surface 602 of the flat plate 600, the next step in the method is to position the flat plate 600 with the adhesive 300 applied thereto against a desired location of a window frame. This can be performed using a holder 100 so that the holder 100 can apply pressure to the flat plate 600 against the window frame, or it can be performed manually without a holder 100.

While the flat plate 600 is held against the window frame under pressure, the next step of the method is to cure the adhesive using UV light. In at least one embodiment, this step is performed using a handheld UV light device 400, such as, for example, the Cool Cure Beam sold by American Ultraviolet, which is a cordless UV LED spot cure device. Exemplary UV light devices 100 of the present disclosure may output wavelengths of 365 nm, 395 nm, and/or 405 nm, at an intensity of 860 mW/cm²-13 W/cm². UV light can be applied using said UV light device 400 for between about 15 seconds and about 30 seconds per flat plate 600 attachment, such as by holding the UV light device 400 about 4-5 inches away from the flat plate 600 and shining said light on the flat plate 600 where the adhesive 300 is located. In other embodiments, less time or more time of UV cure can take place. A holder 100 can be used (if desired) in this step to hold the flat plate 600 in place while applying UV light so that the user's fingers are not in the range of the UV cure light. This step is performed to position and affix one or more flat plates 600, in place upon the relative flat sections of the front or inside top of the window frame.

The next step in the method is to position a window blind 500 upon said positioned flat plates 600 to hold the window blind 500 in place, and securing the window blind 500 to flat plates using nuts 654 positioned upon screws or bolts 650, such as shown in FIG. 9.

FIG. 10 shows an exemplary flat plate 600 of the present disclosure coupled to a window blind bracket 1000. When coupled thereto, and so that part of window blind bracket 1000 sits flat against flat plate 600, a lever pivot mechanism 1004 of window blind bracket 1000 can be positioned within indentation 608 defined within flat plate 600. This allows lever 1002 of window blind bracket 1000 to be adjusted while window blind bracket 1000 is coupled to flat plate 600.

The L-shaped brackets 100 and the flat plates 600 referenced herein may be generally referred to as “devices.”

While various embodiments of devices and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A method of securing a device to a window frame, the method comprising:
applying an ultraviolet (UV) light curable adhesive to the device;
positioning the device upon the window frame and holding the device in place; and
applying UV light to the device using a handheld UV light device to cure the adhesive and install the device to the window frame.

2. The method of claim 1, wherein the device comprises an L-shaped bracket.

3. The method of claim 2, further comprising the step of:
cleaning relative corners of a window frame that will receive a window blind prior to the step of positioning the device upon the window frame.

4. The method of claim 2, wherein the step of positioning the device upon the window frame and holding the device in place comprises using a holder configured to receive part of the device.

5. The method of claim 4, wherein the step of applying UV light to the device is performed while the holder is used to hold the device in place upon the window frame.

6. The method of claim 5, further comprising the step of:
removing the holder from the device.

7. The method of claim 6, further comprising:
repeating the method to install at least a second L-shaped bracket.

8. The method of claim 7, further comprising:
installing a window blind upon the installed L-shaped brackets.

9. The method of claim 4, wherein the holder comprises a handle and an engagement portion positioned at a distal end of the handle, wherein the engagement portion has a slot defined therein with a slot opening at a distal end of the engagement portion, the slot configured to receive and engage a bracket flange of the L-shaped bracket.

10. The method of claim 1, wherein the device comprises a flat plate, the flat plate comprising:
an inner surface;
an outer surface; and
at least one hole defined within the flat plate and countersunk from the inner surface, the at least one hole configured to receive at least part of a screw or bolt therethrough.

11. The method of claim 10, further comprising the step of:
cleaning relative flat sections of the front or inside top of the window frame that will receive a window blind prior to the step of positioning the device upon the window frame.

12. The method of claim 10, wherein the step of positioning the device upon the window frame and holding the device in place comprises using a holder configured to receive part of the device.

13. The method of claim 12, wherein the step of applying UV light to the device is performed while the holder is used to hold the device in place upon the window frame.

14. The method of claim 10, further comprising the steps of:
positioning a window blind bracket onto the flat plate installed to the window frame; and
securing the window blind bracket onto the flat plate using one or more nuts.

15. The method of claim 14, further comprising:
repeating the method to install at least a second flat plate.

16. The method of claim 15, further comprising:
installing a window blind upon the installed flat plates.

17. A method of securing a device to a window frame, the method comprising:
cleaning at least a portion of a window frame that will receive a window blind;
applying an ultraviolet (UV) light curable adhesive to the device;
positioning the device upon the window frame and holding the device in place; and
applying UV light to the device using a handheld UV light device to cure the adhesive and install the device to the window frame.

18. The method of claim 17, wherein the device comprises an L-shaped bracket, wherein a holder is used to hold the L-shaped bracket in place while the step of applying UV light is performed.

19. The method of claim 18, further comprising the step of:
installing a window blind to the device to hold the window blind in place.

20. The method of claim 18, wherein the device comprises a flat plate, and wherein the method further comprises the steps of:
positioning a window blind bracket onto the flat plate installed to the window frame; and
securing the window blind bracket onto the flat plate using one or more nuts.
